(19) United States
(12) Patent Application Publication
(10) Pub. No.: US 2004/0132495 A1
(43) Pub. Date: Jul. 8, 2004

(54) System and method for managing communications with mobile platforms operating within a predefined geographic area

(76) Inventors: Edwin T. Horton JR., Wildwood, MO (US); Timothy M. Mitchell, Seattle, WA (US); Wayne F. Cavanaugh, Kent, WA (US)

Correspondence Address: HARNESS, DICKEY & PIERCE, P.L.C., P.O. BOX 828, BLOOMFIELD HILLS, MI, 48303, US

(21) Appl. No.: 10/655,923

(22) Filed: Sep. 5, 2003

Related U.S. Application Data
(60) Provisional application No. 60/409,335, filed on Sep. 9, 2002.
(60) Provisional application No. 60/408,846, filed on Sep. 6, 2002.

(51) Int. Cl. H04M 1/00

(52) U.S. Cl. 455/562.1

(57) ABSTRACT

A system and method for providing communications within an airfield between an aircraft component located upon an aircraft and an airport data network. A control computer is used to select an optimal antenna substation from a plurality of antenna substations disposed about the airfield for the aircraft component to communicate with. The selection is based in part upon position information including the directional heading of the aircraft, determined using a suitable position detecting system, such as a Global Positioning System or a multi-lateration system, and in part upon the loading (i.e., RF traffic) being experienced by each antenna array. Determining the optimal antenna array for the aircraft to communicate with based on the directional heading of the aircraft and the real time usage of each of the antenna substations is advantageous as it decreases the number of times that the aircraft must initiate a new connection with a new antenna substation, and therefore decreases the transmission interruptions experienced due to the creation of new connections.

### CROSS-REFERENCE TO RELATED APPLICATIONS

This application claims priority from U.S. S No. 60/409,335; filed Sep. 9, 2003, presently pending, and from U.S. S No. 60/408,846, filed Sep. 6, 2002, presently pending.

### FIELD OF THE INVENTION

The present invention generally relates to systems and methods for data transmission. In particular, the present invention relates to RF data transmission between mobile platforms, such as aircraft, and a plurality of antenna subsystems located at a controlled area, such as at an airfield, to more efficiently utilize the capacity of the antenna substations.

### BACKGROUND OF THE INVENTION

In conventional wireless network architectures, the radio frequency (RF) connections made between mobile platforms, such as aircraft, and particular RF communication access points disposed about a controlled area, such as at an airfield, is typically accomplished using very high frequency “line-of-sight” transmissions for modulating data between the aircraft and a ground-based control center in communication with the aircraft. Typically, frequencies in the range of about 2 GHz to about 6 GHz are employed for this purpose. Transmissions at such high frequencies facilitate extremely robust data transmission rates and provide excellent bandwidth for transmitting very large amounts of data very quickly between the aircraft and the ground-based control center. Such high frequency, line-of-sight transmissions are often handled in accordance with well known 802.11a or 802.11b communications protocols.

However, a drawback with the use of such high frequency RF transmissions is the limited distance over which such signals may be transmitted. Typically, this distance is about 1000 yards (910 meters) or less for such systems employed at airfields. Thus, when implementing a wireless, high frequency communications system at a controlled area such as an airport or airfield, where runways and taxiways may extend for significant distances and therefore define a relatively large, controlled area, a plurality of antenna substations must be employed. The antenna substations that are intended to communication with the aircraft as the aircraft taxis about the airfield, or is parked at various areas at the airfield for short or long periods, must be sufficient in number and strategically located at those areas around the airfield to ensure that communications can be maintained with an aircraft at all times during which the aircraft is present at the airfield.

With present day airfield traffic management systems the access to the antenna substations is also un-managed. By “un-managed”, it is meant that the decision as to which antenna substation a particular aircraft should communicate which is based upon which antenna substation provides the strongest RF signal to the aircraft, as detected by the RF equipment carried by the aircraft. During situations where many aircraft are accessing the antenna substations simultaneously, this may result in some antenna substations being utilized to capacity while others with a similar coverage area are underutilized, thus leading to network bottlenecks and inefficiency in the communications with the aircraft operating at the airfield or airport. An underlying cause of this problem is the lack of knowledge about each aircraft's position, travel direction and speed, as well as a lack of consideration of the location, antenna type, orientation, and coverage area of the antenna substations.

An additional problem with un-managed, wireless communications systems for managing communications between aircraft and a ground based communications network stems from the transmission delay experienced when the network transfers an aircraft from one antenna substation to another at the airfield. Such delays are often experienced in signal strength based networks as such networks often transfer communications from one antenna substation to another due to the natural signal strength fluctuations experienced with RF transmissions. This can lead to frequent transfers of communication between the aircraft and various antenna substations at the airfield as the aircraft taxies about the airfield. This, in turn, can produce frequent delays in passing important data from the ground based network to the aircraft. With present day systems that rely on signal strength as the means for selecting a particular antenna substation to communicate with, natural signal strength fluctuations can result in the aircraft making and breaking RF connections many times in a very short time period, even while the aircraft is parked at an airfield. This is because with some existing systems at certain airports, an aircraft would be able to detect a beacon signal from several antenna substations simultaneously. The naturally varying signal strengths will prompt the RF communications system on the aircraft to repeatedly make and break communications links with various antenna substations in an effort to maintain communication with the substation providing the strongest beacon signal. Since each interruption in communication can represent a time period of one or more seconds, a large of amount of data transmitted to the aircraft can be lost each time an interruption in the communications link with an aircraft occurs.

Thus, there exists a need for an improved airport traffic management system that is capable of monitoring communications with a large number of aircraft on the ground at an airport and determining the optimal antenna substation to be used by each aircraft, in real time fashion, to even more efficiently manage communications between parked or taxing aircraft at an airport and a ground-based central data network. Specifically, there is a need for a communications system that is able to determine the optimal access point to be used by ground based aircraft, which is not limited to the consideration of the signal strength of received RF beacon signals by the aircraft's RF communications system. This would reduce the frequency of changes by the aircraft in the specific access point with which it is communicating, and therefore reduce the number of instances where communication is lost between the ground based aircraft and the central data network due to the initiation of a new communications link with a different access point. Further, there is a need for a communications system that can monitor and manage the number of aircraft that are communicating with a given access point at a given time to eliminate network bottlenecks and network inefficiencies.

### SUMMARY OF THE INVENTION

The present invention overcomes the deficiencies of the prior art by providing an improved communications system for use in a controlled environment, such as within an airfield, between a mobile platform, such as an aircraft, and a centralized ground communications network, such as an airport central data network located at an airport or airfield. Specifically, the present invention provides for a control computer that selects the optimal antenna substation for the aircraft to communicate with from a plurality of antenna substations located about the airfield. The decision as to which antenna substation to select is based in part upon the directional heading of the aircraft that is determined using Global Positioning System (GPS) information from GPS satellites, and based in part upon the RF traffic being handled (i.e., loading) of each particular antenna substation. Determining the optimal antenna substation for the aircraft to communicate with based on the directional heading of the aircraft and upon the present usage of the different antenna substations is advantageous as it decreases the number of times that the aircraft must initiate a new connection with a different antenna substation. It also decreases the transmission interruptions experienced due to the initiation of new RF connections.

In an alternative preferred embodiment, the aircraft's position at an airfield at any given time is determined by multi-lateration techniques instead of by GPS information. Positional information concerning the aircraft is then used, together with additional information concerning the direction of travel of a moving aircraft and its speed, by a control computer to determine the appropriate access point for a given aircraft.

Further areas of applicability of the present invention will become apparent from the detailed description provided hereinafter. It should be understood that the detailed description and specific examples, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram generally illustrating a communications system of the present invention, and specifically illustrating an aircraft component and a ground based component, and where the ground based component includes a plurality of antenna substations disposed about an airfield that are used to provide communication between the aircraft and a central data network;

FIG. 2 is a top view of a portion of an airfield at which the communications system of FIG. 1 may be used; and

FIG. 3 is a flow chart-like illustration of the communication steps performed by a control computer and the aircraft component of FIG. 1, and the interaction between the control computer and the aircraft component in establishing a communications link.

### DETAILED DESCRIPTION OF THE PREFERRED EMBODIMENTS

The following description of the preferred embodiments is merely exemplary in nature and is in no way intended to limit the invention, its application, or uses.

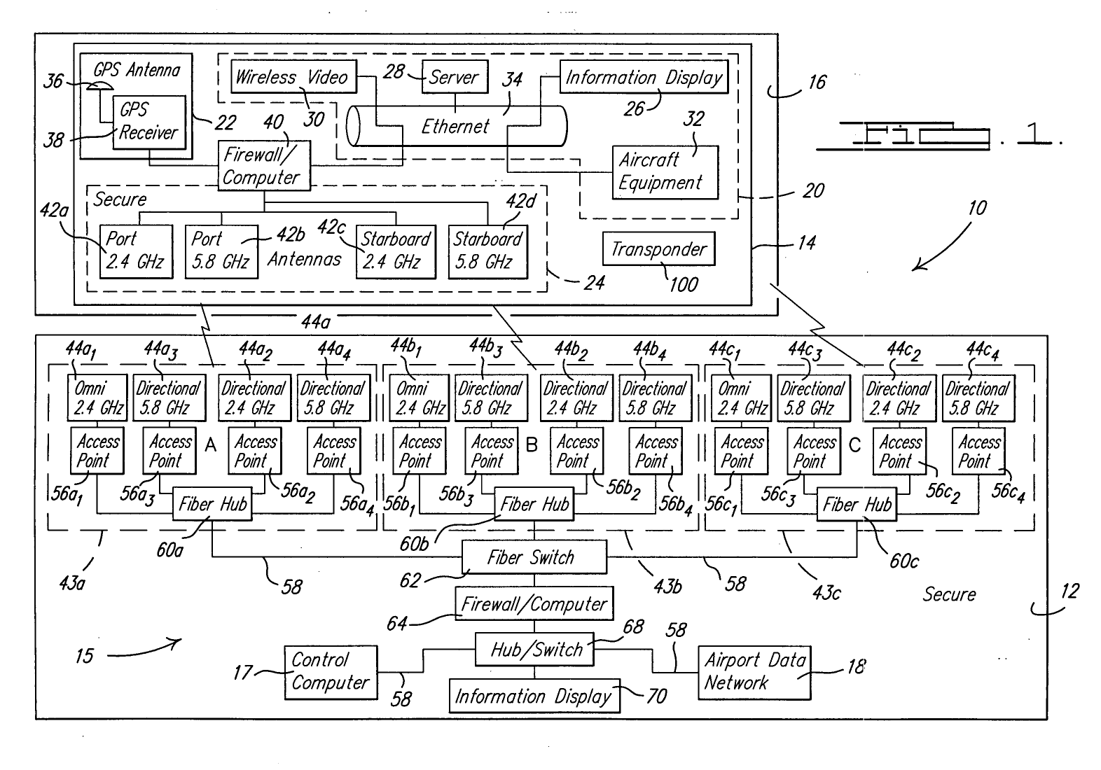

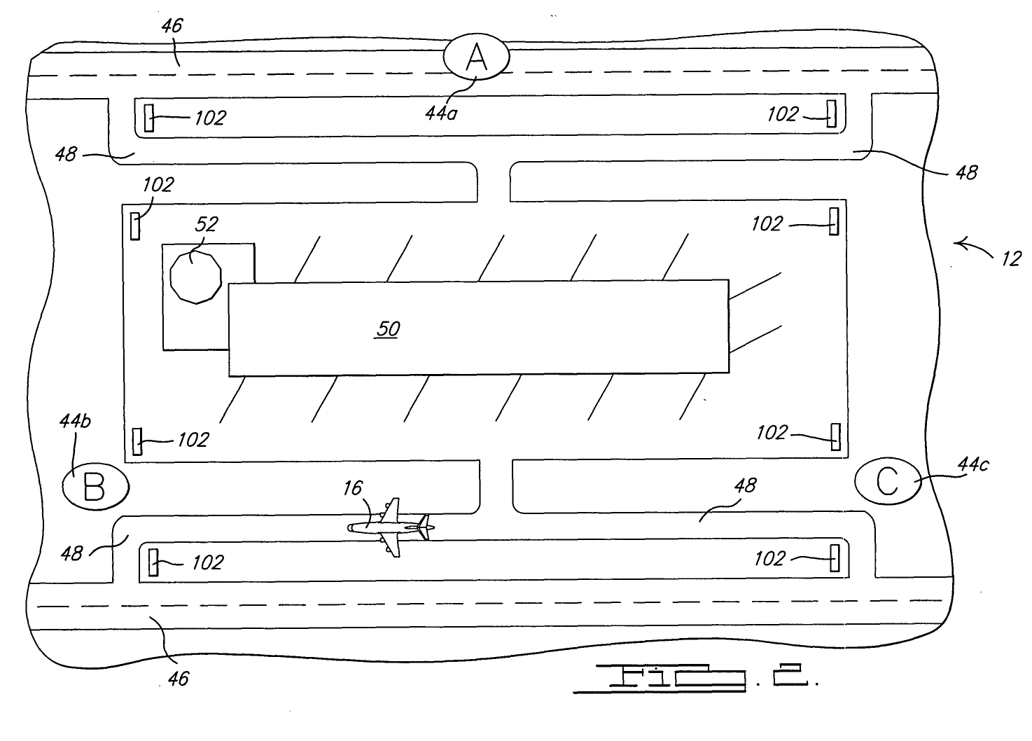

With initial reference to FIG. 1, a communications system in accordance with a preferred embodiment of the present invention is generally illustrated at 10. The communications system 10 is used in a controlled environment such as at an airfield 12. The system 10 includes an aircraft communications component 14 located onboard a mobile platform such as an aircraft 16 (FIG. 2), and a ground based component 15. The ground based component 15 includes a control computer 17. The ground based component 15 provides communication between the aircraft communications component 14 and a remote data network 18, which may be part of the ground based component 15 or that may be a separate system accessed by the system 10. While the following description focuses on the application of communications system 10 to an airfield 12 with an aircraft component 14 of an aircraft 16, it will be appreciated that the system 10 may be used in any controlled environment where a plurality of mobile platforms (e.g. motor vehicles, ships, etc.) need to simultaneously access a plurality of communications substations at a controlled area. Thus the description of the mobile platforms as aircraft 16 is only exemplary and the present invention is not limited to use only with aircraft operating within the confines of an airfield.

The aircraft communications component 14 will now be described in greater detail. The aircraft communications component 14 is generally comprised of an aircraft data network 20, a device for determining the location and heading of the aircraft 16 such as a global positioning system (GPS) 22, and an antenna array 24. The aircraft data network 20 represents components that are pre-existing on each aircraft 16. The network 20 is comprised of an information display 26, a server 28, a video device 30 (possible as a wireless video device), and various other types of aircraft equipment 32. The different components of the data network 20 are interconnected through a local area network connection such as an Ethernet connection 34.

The GPS 22 determines the location and heading of the aircraft 16 through communication with navigation satellites (not shown) using GPS antenna 36. The navigation information received from the navigation satellites is received and processed by a GPS receiver 38.

The navigation information of the GPS 22 and the data from the aircraft data network 20 is prepared for transmission and encrypted by firewall/computer subsystem 40. The firewall/computer subsystem 40 may comprise any suitable computer system which includes an encryption device capable of encrypting data to allow the data to be transmitted with a suitable degree of security.

The antenna array 24 may comprise any suitable number and types of RF antennas, but in one preferred form is comprised of four separate RF antennas 42. It will be appreciated, however, that the aircraft communications component 14 could incorporate only a single RF antenna. Providing a plurality of antennas 42, however, provides added flexibility to the system 10.

The antennas 42 include a 2.4 GHz port side antenna 42a, a 5.8 GHz port side antenna 42b, a 2.4 GHz starboard side antenna 42c, and a 5.8 GHz starboard side antenna 42d. Port side antennas 42a and 42b are located toward the port side of the exterior of the aircraft 16 while starboard antennas 42c and 42d are located on an exterior surface toward the starboard side of the aircraft. The use of antennas for operating at two different frequencies further ensures that if RF traffic on one frequency is very high, that a second frequency is available for use.

The antenna array 24 transmits the encrypted data of the GPS 22 from the aircraft component 14 to the control computer 18 by way of a series of antenna substations 43a, 43b and 43c. Each antenna substation 43 includes an antenna array 44 that is located at a predetermined location at the airfield 12. The encrypted data may be transmitted in a variety of different formats but is preferably transmitted using well known 802.11a or 802.11b protocols. The data from the aircraft data network 20 may also be transferred via antenna array 24, however, the transmission of data from the aircraft data network 20 is not the principal purpose for the invention.

In FIG. 2, the antenna substations 43 are illustrated at various predetermined locations at the airfield 12. The airfield 12 is comprised of at least one runway 46, at least one taxiway 48, a terminal 50, and a control tower 52. While FIGS. 1 and 2 illustrate three antenna substations 43a, 43b, and 43c, it must be realized that any suitable plurality of antenna substations 43 may be incorporated. The antenna substations 43 are located about the airfield 12 at those locations sufficient to provide communication with an aircraft at any area where the aircraft might be required to taxi or might be parked.

All of the antenna substations 43 transmit a “beacon” signal from their respective antenna array 44 that identifies the source of the beacon signal and an SSID (Service Set Identification), which is a unique identifier exclusive to the system 10. Antenna arrays 44 in close proximity are on different frequencies to further help prevent self jamming. The aircraft data network 20 knows the SSID and scans the frequencies associated with the antenna arrays 44 looking for a beacon signal. If it detects only one, then it will commence communications at that frequency and with that particular antenna array 44 associated with the received beacon signal. If it detects more that one beacon signal, then the signal having a stronger received signal strength will be selected and locked onto by the aircraft data network 20.

As seen in FIG. 1, each antenna array 44a, 44b and 44c is preferably comprised of at least four antennas. Antenna array 44a includes an omnidirectional antenna 44a₁ tuned to 2.4 GHz, a 2.4 GHz directional antenna 44a₂, and two 5.8 GHz directional antennas 44a₃ and 44a₄. Antenna arrays 44b and 44c similarly include antennas 44b₁-44b₄ and 44c₁-44c₄, respectively. Each antenna of each antenna array 44 is coupled to one of a plurality of access points 56. Thus, antennas 44a₁-44a₄ are coupled to access points 56a₁-56a₄. Antennas 44b₁-44b₄ are similarly coupled to access points 56b₁-56b₄, and antennas 44c₁-44c₄ are similarly coupled to access points 56c₁-56c₄. The access points 56 form RF transceivers that convert the received RF data to electrical signals suitable for transmission through a land-based transmission line. Preferably, the received data is converted to a suitable IP protocol to permit transmission through fiber optic lines 58.

The directional antennas 44a₂-44a₄, 44b₂-44b₄ and 44c₂-44c₄ are used to beam RF signals down the runway 46 and taxiway 48. Accordingly, the various ones of these directional antennas are orientated so that their beams are directed away from each other, and more preferably such that the antennas of array 44a transmit beams at 180 degrees from one another (i.e., in opposite directions) along runway 46. The directional antennas of arrays 44b and 44c are similarly positioned to cover the full length of taxiway 48. The omnidirectional antenna 44a₁, 44b₁ and 44c₁ of each antenna array 44 is used to serve areas not covered by its associated directional antennas. The use of directional antennas 44a₂-44a₄, 44b₂-44b₄ and 44c₂-44c₄ provide greater range and help to reduce self jamming. Self jamming is reduced because the RF signal from one of the directional antennas 44a₂-44a₄, 44b₂-44b₄ and 44c₂-44c₄ is reduced in level when received by the other one of the adjacent directional antennas. This is because of the signal rejection characteristics of each of the directional antennas. This effectively improves the signal-to-jamming margin of each directional antenna.

Each antenna of antenna arrays 44a, 44b and 44c is in communication with an associated fiber hub 60a, 60b and 60c. The fiber hubs 60 are in turn coupled to a fiber switch 62. The data received by fiber switch 62 is de-crypted by any suitable data de-crypting device, such as a firewall/computer subsystem 64. The data is transferred to and from firewall/computer subsystem 64 preferably using fiber optic lines 58. Firewall/computer subsystem 64 also performs an authentication of each aircraft 16 accessing the ground based component 15 to thus control access by the aircraft to the system 10. It will be appreciated that while fiber optics are utilized to handle the transmission of data between the antenna substations 43 and the fiber switch 62, that other suitable data transmission means could be incorporated in lieu of a fiber optic system.

From the firewall/computer subsystem 64, the received data is directed to various subsystems by a hub or switch 68. The subsystems in receipt of the received data preferably include the control computer 17, the airport data network 18, and an information display 70 for visually displaying various operational parameters of the system 10, such as the location and heading of the aircraft 16 and which antenna array 44 the aircraft 16 is in communication with. While the control computer 17 is illustrated as being separate from the airport data network 18, it should be realized that the control computer 17 may be part of the airport data network 18. The control computer 17, information display 70, and airport data network 18 are interconnected by fiber optic lines 58 or any other suitable signal transmission means.

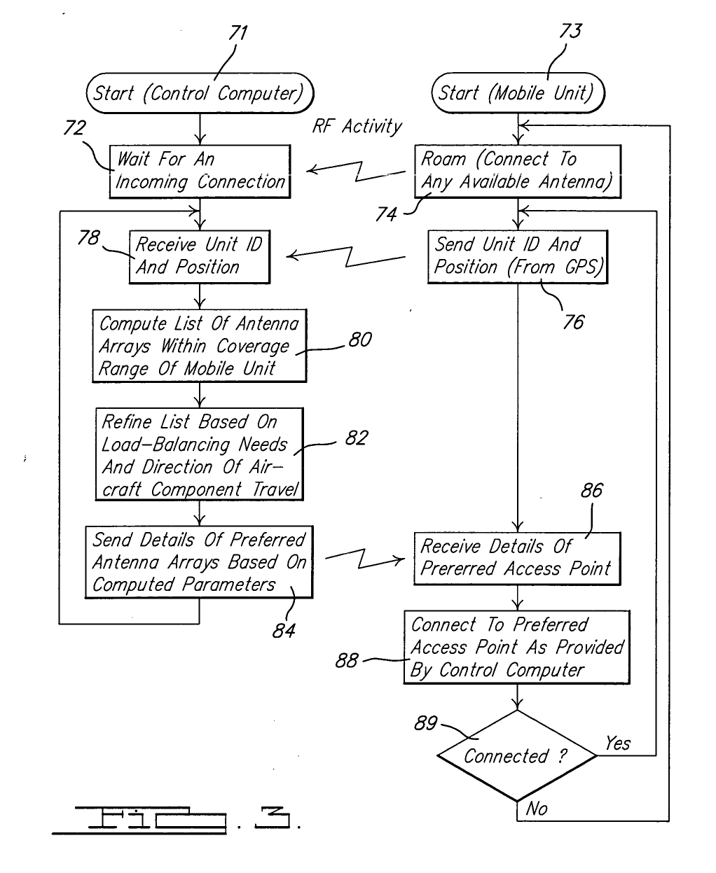

The decision as to which antenna substation 43 aircraft communications component 14 is to connect with in order to communicate with the airport data network 18 is made by control computer 17. The use of control computer 17 to determine which antenna substation 43 the aircraft communications component 14 is to communicate with will now be described in detail. As illustrated in FIG. 3, the control computer 17 is activated at step 71 and waits to receive an incoming data signal from aircraft communications component 14 of a given aircraft 16, as shown at step 72. Once aircraft communications component 14 is activated at step 73, the aircraft communications component 14 performs a roaming operation at step 74 to detect a beacon signal from any one of the antenna arrays 44a,44b,44c. Once it detects such a signal it establishes a communications link with the antenna substation 43a, 43b,43c providing the beacon signal, and then makes a connection with the control computer 17, as shown at step 72.

After the aircraft communications component 14 connects with one of the antenna arrays 44a,44b,44c, the aircraft component 14 transmits a unit identification number (e.g., a tail number) and its position, as determined by GPS 22, to the control computer 17, at step 76. Alternatively, multi-lateration could be used in place of a GPS system to determine the position of the aircraft 16. This position detecting technique will be discussed in connection with an alternative preferred embodiment of the invention.

The unit identification number and position data are received by the control computer at step 78. Once the control computer 17 receives the identification number and position data at step 78, and authenticates the aircraft 16 as an aircraft authorized to access the system 10, the control computer 17 computes a list of antenna arrays 44 that are within the coverage range of the aircraft communications component 14, as at step 80. The list of antenna arrays 44 that is generated by the control computer 17 is modified at step 82 based on antenna array load balancing considerations and the direction of travel of the aircraft 16 to determine the optimal antenna array 44 with which aircraft 16 is to communicate with. For example, FIG. 2 illustrates aircraft 16 as being closest to antenna array 44b. However, if antenna array 44a is presently operating at capacity with respect to the number of aircraft it is in communication with, then the control computer 17 will select a different antenna array 44 which represents the next optimal antenna array. Further, if the aircraft 16 is closest to antenna array 44b but the data from the GPS 22 indicates that the aircraft 16 is traveling away from the antenna array 44b of antenna substation 43b and toward the antenna array 44c of substation 43c, the control computer 17 will select antenna array 44c as the optimal antenna array 44 for the aircraft component 14 to communicate with. This is done to minimize the number of times that the aircraft component 14 must initiate a new connection with antenna arrays 44 as the aircraft traverses the airfield 12, and thus minimize the communication delays associated with establishing new communications links.

Once the optimal antenna array 44 is selected by control computer 17, the details of the optimal antenna array 44 are transmitted to the aircraft communications component 14 at step 84 and received by the aircraft communications component 14 at step 86. The aircraft communications component 14 connects to the optimal antenna array 44 as indicated at step 88. If the aircraft communications component 14 successfully connects to the antenna array 44 selected by the control computer 17 at step 89, the operation of the aircraft communications component 14 proceeds to step 76. At this step the unit identification number and the heading of aircraft 16 are again transmitted to the control computer 17 to allow the control computer 17 to continuously update its decision as to which antenna array 44 is the optimal antenna array for the aircraft 16 to communicate with. If the aircraft communications component 14 is unable to connect to the preferred antenna array 44 at step 89 the operation of the aircraft component 14 proceeds to step 74 where the aircraft communications component 14 of the aircraft 16 connects with any available antenna array 44 until the component 14 is able to connect to the optimal antenna array 44 as selected by control computer 17.

An additional advantage to using “sectorized” (i.e., spaced apart) antennas is that it allows a system to be designed with a near optimum frequency plan incorporating frequency reuse. Since omnidirectional antennas transmit in all directions, a frequency can be reused at a different antenna station only if the distance between the omnidirectional antennas is great enough to avoid interference. Sectored antennas restrict the RF pattern, so frequency reuse in close proximity is possible as long as it is in a sector that does not overlap with a sector on the same frequency.

In an alternative preferred embodiment, the technique of multi-lateration is used to provide the needed positional information of each aircraft 16 located at an aircraft. In this embodiment, the aircraft 16 includes an RF transponder 100 as part of its communications component 14, as shown in FIG. 1. It will be appreciated that when multi-lateration is used, the GPS subsystem 22 will not be required.

Briefly, and with reference to FIG. 2, multi-lateration is a well known technique involving the use of multiple, non-rotating RF receivers 102 disposed at various locations about the airfield 16. The RF receivers 102 are used to capture pulses being transmitted from the RF transponder 100 of each aircraft 16. From these pulses, an external processing system associated with the RF receivers 102 extrapolates the position of the aircraft 16 at any given instant. Multi-lateration differs from a GPS based system because a GPS based system uses a single receiver (i.e., on the aircraft 16) to capture signals transmitted from a plurality of widely spaced satellites. One manufacturer of a multi-lateration system suitable for use with the present invention is Senesis Corporation of DeWitt, N.Y. The receivers 102 could be located at the antenna substations 15 or at other areas about the airfield 12. Since they are physically small components, they are easily mounted on other support structures or pre-existing buildings at the airfield 12. The resolution of the position information extrapolated from the receivers 102 is limited principally by the number of receivers 102 employed. Accordingly, the greater the number of receivers 102 located about the airfield 12 the greater the precision with which each aircraft's 16 location can be pinpointed at any given time.

Thus, the present invention discloses an improved communications system 10 for providing communications in a controlled environment, such as within the airfield 12, between a mobile unit, such as the aircraft component 14 of aircraft 16, and a remote network, such as the airport data network 18. Specifically, the present invention provides for a control computer 17 that selects the optimal antenna substation 43 from a plurality of antenna substations disposed about an airfield for the aircraft 16 to communicate with. This determination is based in part upon the position, direction of travel and speed of the aircraft 16, calculated using suitable position information, and in part upon the current load (i.e., number of aircraft) being handled by each antenna substation 43. Determining the optimal antenna substation 43 for aircraft component 14 to communicate with based on the directional heading of the aircraft 16 and the real time usage of each antenna substation 43 is advantageous as it decreases the number of times that aircraft communications component 14 must initiate communication with a new antenna array 44, and thus decreases the transmission interruptions experienced due to the creation of new connections.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for managing communication between a mobile platform operating within a pre-defined geographic region and a communications station, the system comprising:
a control system for managing communications within said geographic region;
a mobile platform communications component located on said mobile platform for communicating with said control system;
a plurality of antennas located at spaced apart locations within or adjacent said geographic region, each of said antennas being in communication with said control system; and
wherein said control system uses an operating characteristic of said mobile platform as said mobile platform operates within said geographic region to inform said mobile platform as to which one of said antennas to communicate with to maintain a communications link between said mobile platform and said control system while reducing a frequency with which said mobile platform is required to switch between different ones of said antennas as said mobile platform moves within said geographic region.

2. The system of claim 1, wherein said operating characteristic comprises real time position information of said mobile platform.

3. The system of claim 1, wherein said operating characteristic comprises real time information relating to a direction of travel of said mobile platform.

4. The system of claim 1, wherein said operating characteristic comprises real time information relating to a speed of travel of said mobile platform.

5. The system of claim 1, wherein said control system uses information relating to a loading of each of said antennas in determining which one of said antennas said mobile platform is to use for communication purposes.

6. A system for managing communications with a mobile platform operating within a pre-defined geographic region, comprising:
a mobile platform communications component located on said mobile platform for determining a location of said mobile platform while said mobile platform is operating within said pre-defined geographic region;
at least one antenna located on said mobile platform;
a ground based component including:
a plurality of antennas located at spaced apart locations about said pre-defined geographic region;
a control system in communication with said antennas; and
wherein said control system analyzes location information received by at least one of said antennas and selects a specific antenna with which said mobile platform communications component is to use for communicating with a network disposed at said pre-defined geographic region, said selection being made based at least in part on real-time location information for said mobile platform.

7. The system of claim 6, wherein said location information is provided to said control system by said mobile platform.

8. The system of claim 6, wherein said location information is derived by said control system through multi-lateration techniques.

9. The system of claim 7, wherein said location information is derived from Global Positioning Satellite information and supplied to said control system by said mobile platform communications component.

10. The system of claim 6, wherein said selection is further made in consideration of a speed of travel of said mobile platform.

11. The system of claim 6, wherein said selection is further made in consideration of a loading of at least a pair of said antennas.

12. The system of claim 6, wherein each said antenna comprises an antenna substation comprised of at least one directional antenna and an omni directional antenna.

13. The system of claim 6, wherein said ground based component further includes a hub for facilitating communication between said antennas and said control system.

14. The system of claim 6, wherein each said antenna transmits a unique beacon signal, and wherein said mobile platform communications component initially selects one of said beacon signals having the strongest signal strength to establish a communications link with said ground based component.

15. The system of claim 6, wherein said control system further uses information relating to a speed of travel of said mobile platform to make said selection.

16. The system of claim 6, wherein said control system uses information related to a direction of travel of said mobile platform to make said selection.

17. A system for managing communications between a mobile platform operating within a pre-defined terrestrial, geographic region, in a manner to minimize interruptions to a communications link established between the mobile platform and a communications center at the geographic region, the system comprising:
a communications component disposed on said mobile platform, said communications component including a system for providing real time location information;
a ground based component including:
a plurality of antenna stations disposed at predetermined locations about geographic region for providing radio frequency (RF) communications with said mobile platform at any location within said geographic region;
a control system in communication with each of said antenna stations; and
wherein said control system uses said location information and a direction of travel of said mobile platform to determine which of said antenna stations to communicate with and to instruct said mobile platform to switch from one of said antenna stations to another in a manner to minimize a number of changes between said antenna stations while said mobile platform travels within said geographic region, and while maintaining an optimal RF communications link between said mobile platform and said ground component.

18. The system of claim 17, wherein said mobile platform includes first and second RF antennas each operating at a different frequency.

19. The system of claim 17, wherein each said antenna station includes first and second antennas operating at different frequencies.

20. The system of claim 17, wherein the control system uses information concerning a loading of at least a pair of said antenna stations in determining which said antenna stations to instruct said mobile platform to use.

21. The system of claim 17, wherein said location information comprises real-time information obtained from a Global Positioning Satellite system.

22. The system of claim 17, wherein a speed of travel of the mobile platform is used by the control system to select and switch between ones of said antenna stations.

23. The system of claim 17, wherein at lease one of said antenna stations is used to inform said mobile platform as to which specific one of said antenna stations to communicate to switch to using.

24. The system of claim 17, wherein each said antenna station includes:
a directional antenna;
an omni directional antenna; and
wherein said directional antennas of said antenna stations are directed such that an associated antenna beam of each is directed away from one another.

25. The system of claim 17, wherein each said antenna station transmits a beacon signal identifying it to said communications component.

26. A method for managing communications within a pre-defined geographic area between a mobile platform operating within the geographic area and a control system, comprising:
a) using a plurality of ground-based antenna stations, each disposed at fixed locations within the geographic area, to each transmit an identification;
b) using a communications component located on said mobile platform to receive said beacon signals and to select an initial one of said antenna stations to establish a communications link with said control system as said mobile platform operates within said geographic region;
c) using said control system to communicate with each of said antenna stations and to monitor at least one of speed of travel and direction of travel of said mobile platform within said geographic region;
d) using said control system to analyze information obtained at step c) to determine when said mobile platform should switch from communicating with said initial one of said antenna stations to a different one of said antenna stations to maintain an optimal communications link while moving within said geographic region; and
e) instructing said communications component, in real time, as to which one of said antenna stations to use to maintain said communications link in a manner which reduces a frequency with which said communications component is required to switch from one said antenna system to another.

27. The method of claim 26, wherein said communications component continuously supplies location information obtained from a Global Positioning Satellite system to said control system via said antenna stations.

28. The method of claim 26, wherein said control system uses multi-lateration to periodically determine at least an approximate direction of travel of said mobile platform.

29. The method of claim 26, wherein said control system uses both of said directional of travel and speed of travel of said mobile platform in determining which one of said antenna stations to instruct said communications component to switch to so as to maintain said communications link.

30. The method of claim 26, wherein using said antenna stations comprises using antenna stations that each comprise a directional antenna aimed in different directions.

31. The method of claim 26, wherein using said antenna stations further comprises using at least one directional antenna and one omni directional antenna.

32. The method of claim 26, further comprising using information pertaining to a loading of at least a pair of said antenna stations in determining which one of said antenna stations said communications component is to be instructed to use.

33. A method for managing communications within a pre-defined geographic area between a mobile platform operating within the geographic area and a control system, comprising:
locating a plurality of ground-based antenna stations, each disposed at fixed locations within the geographic area;
using at least one of the ground-based antenna stations to transmit an identifying signal;
using a communications component located on said mobile platform to receive said identifying signal and to establish a communications link with said control system via said one of said antenna stations as said mobile platform travels within said geographic area;
using said control system to analyze position information relating to said mobile platform as said mobile platform moves within said geographic area;
using said control system to determine when said communications component should switch from said one antenna station to a different one of said antenna stations to maintain an optimal communications link with said communications component while minimizing a number of times that switching between different ones of said antenna stations occurs; and
using the control system to inform said communications component, via at least one of said antenna stations, which of said antenna stations to switch to so as to maintain said communications link.

34. The method of claim 33, further comprising using said control system to determine a loading of at least a pair of said antenna stations and using said loading in determining which one of said antenna stations to instruct said communications component to switch to.
